(19) United States
(12) Patent Application Publication
(10) Pub. No.: US 2024/0359801 A1
(43) Pub. Date: Oct. 31, 2024

(54) PARALLEL HYBRID POWERPLANT WITH TURBOFAN ENGINE CORE

(71) Applicant: VerdeGo Aero, Inc., Daytona Beach, FL (US)

(72) Inventors: Richard Pat Anderson, De Leon Springs, FL (US); David N. Spitzer, Port Orange, FL (US); Eric Richard Bartsch, Wilmette, IL (US); Xavier Gerardo Santacruz, Port Orange, FL (US)

(21) Appl. No.: 18/771,463

(22) Filed: Jul. 12, 2024

Related U.S. Application Data
(63) Continuation of application No. PCT/US23/10956, filed on Jan. 17, 2023.
(60) Provisional application No. 63/299,794, filed on Jan. 14, 2022.

(51) Int. Cl. B64D 27/33; B64D 27/16; B64D 31/18; F01D 15/10; F01D 15/12

(52) U.S. Cl. CPC B64D 27/33; B64D 31/18; F01D 15/10; F01D 15/12; B64D 27/16; F05D 2260/4031

(57) ABSTRACT

A hybrid aircraft powerplant includes a turbine engine having a first shaft configured to output power from the turbine engine, a bypass fan, and an electric machine. The hybrid aircraft powerplant further includes a first mechanism configured to selectively engage the first shaft with a second shaft connected to the electric machine such that the power is output from the turbine engine to the electric machine. The hybrid aircraft powerplant further includes a second mechanism configured to selectively engage the first shaft with a third shaft connected to the bypass fan to output the power from the turbine engine to the bypass fan.

### CROSS-REFERENCE TO RELATED PATENT APPLICATIONS

This application is a continuation of PCT/US2023/010956, filed Jan. 17, 2023, which claims the benefit of U.S. Provisional Patent Application No. 63/299,794, filed Jan. 14, 2022, the entire contents of each of which are hereby incorporated by reference in their entirety.

### BACKGROUND

There are varying types of aircraft that are propelled using different types of propulsion mechanisms, such as propellers, turbine or jet engines, rockets, or ramjets. Different types of propulsion mechanisms may be powered in different ways. For example, some propulsion mechanisms like a propeller may be powered by an internal combustion engine or an electric motor. Other propulsion mechanisms like a turbofan may be powered by a turbine engine.

### SUMMARY

In an embodiment, a hybrid aircraft powerplant includes a turbine engine having a first shaft configured to output power from the turbine engine, a bypass fan, and an electric machine. The hybrid aircraft powerplant further includes a mechanism configured to selectively engage the first shaft with a second shaft connected to the electric machine such that the power is output from the turbine engine to the electric machine.

In an embodiment, a hybrid aircraft powerplant includes a turbine engine having a first shaft configured to output power from the turbine engine, a bypass fan, and an electric machine. The hybrid aircraft powerplant further includes a mechanism configured to selectively engage the first shaft portion with a second shaft connected to the bypass fan to output the power from the turbine engine to the bypass fan.

In an embodiment, a method includes controlling a turbine engine including a first shaft to output power via the first shaft. The method further includes controlling, in a first mode of operation, a first mechanism to engage the first shaft with a second shaft. The second shaft is connected to an electric generator, such that the power is output from the turbine engine to the electric generator via the first shaft and the second shaft. The method further includes controlling, in a second mode of operation, the first mechanism to engage the first shaft with the second shaft while also controlling a second mechanism to engage the first shaft to a third shaft. The third shaft is connected to a bypass fan, such that the power is output from the turbine engine to each of the electric generator and the bypass fan.

### BRIEF DESCRIPTION OF THE DRAWINGS

FIG. 1 illustrates a side cross-sectional view of a turbofan in accordance with an illustrative embodiment.

FIGS. 2A-2D are schematics showing example turbofans with an electric machine and mechanisms such as clutches in accordance with various illustrative embodiments.

FIG. 3 is a schematic showing an example turbofan with an electric machine between a turbine engine and a bypass fan in accordance with an illustrative embodiment.

FIG. 4 is a schematic showing an example turbofan with an electric machine connected to a shaft extending from a turbine engine in accordance with an illustrative embodiment.

FIG. 5 illustrates a block diagram representative of an aircraft control system for use with a hybrid powerplant having a turbofan engine core in accordance with an illustrative embodiment.

FIG. 6 is a flow chart illustrating a use of a hybrid powerplant having a turbofan engine core in accordance with an illustrative embodiment.

FIG. 7 illustrates a block diagram representative of an electric machine having a plurality of sectors and a system for powering aircraft components with the electric machine in accordance with an illustrative embodiment.

FIG. 8 is a diagrammatic view of an example of a computing environment, in accordance with an illustrative embodiment.

### DETAILED DESCRIPTION

One aspect of aviation flight is the ability to travel very fast through the air. The forward motion can be created by one or more propellers, one or more fans, or a number of jet engines. As higher speeds are prioritized, propellers and fans may fall away as viable options and the only remaining solution is some form of turbine engine commonly called a jet. Described herein are hybrid powerplants that can advantageously power an aircraft to takeoff and land vertically (e.g., VTOL aircraft), short takeoff and landing (e.g., STOL), or any other aircraft for which a mix of physical thrust and electrical power is desirable from an aircraft power plant, while also potentially facilitating faster horizontal flight than is possible using forward thrust mechanisms like propellers. This provides for aircraft that advantageously open up new opportunities for travel or transport of goods, such as by eliminating in many cases the need for any sort of prepared runway.

Described herein are various embodiments for a parallel hybrid system architecture built around a high-performance turbofan engine. In various embodiments, aspects of a powerplant described herein other than the turbofan engine itself may be used with other types of engines, such as any engine having a turbine and turbine core. For example, turboshaft or turboprop engines may be used instead of a turbofan engine. A turboprop engine may, for example, include gearing to adjust the output of a turbine down to usable propeller speeds such as 1500-2500 rotations per minute (RPM). This solution advantageously provides for a turbofan to act as normal by capturing, pressurizing, and discharging air through a bypass fan driven by a turbine engine, while also being capable of transitioning to a very high output electric generator to feed high voltage and high-power energy via distribution wires to motors and/or other components, such as those that are adapted for vertical lift (e.g., for a vertical takeoff and landing (VTOL) aircraft). This combination of a turbofan for generating forward thrust for flight along with a blended transition to electric power generation powered by a turbine engine may advantageously facilitate and power flight modes as well as various accessories of an aircraft in ways not previously possible. In particular, in various embodiments described herein, a shaft of a turbine engine may be able to power a bypass fan (e.g., as in a turbofan) while also using the same shaft to power an electric machine (e.g., an electric generator and/or electric generator/motor combination). The single shaft may enable each of the components to be oriented in a parallel fashion. Clutches associated with each of the bypass fan and electric machine may enable selective connection between the bypass fan and the shaft as well as the electric machine and shaft, such that the bypass fan and electric machine may be powered by the shaft together or separately based on the state of the clutches. In various embodiments, various types of turbine engines and electric machines may be connected in a powerplant with a shaft without the use of clutches.

In aviation, weight of an aircraft may be a primary concern and/or design constraint. A benefit of the parallel hybrid turbofan (or other types of turbine engines such as turboshaft or turboprop) design described herein is that one core thermal engine can produce two very different forms of propulsion on the same aircraft. In terms of thrust-to-weight ratio for atmospheric flight, a turbofan is quite effective compared to other types of powerplants, which is why they find value, for example, on commercial airliners and business jets. As described herein, a turbofan engine may also be used to efficiently create power on the order of one or many Megawatts (MW) of electric power that may be used in other aircraft to enable distributed electric propulsion, such as in vertical takeoff and landing (VTOL) aircraft. Other benefits to the various embodiments herein may include improved center of gravity of powerplant components, efficient cooling, and control.

The powerplants described herein may therefore be advantageously useful in aircraft that are design for high speed travel but also use distributed electric propulsion (DEP), or otherwise have large electrical power demands. DEP applications may include uses in aircraft such as VTOL, boundary layer control, blown wing for short-takeoff-and-landing (STOL), or other unique applications of DEP.

More specifically, described herein are hybrid powerplants based around a turbofan engine that is configured to deliver forward thrust via a bypass fan, with the added capability to generate high electrical power output for uses such as propulsion or other electrical uses on an aircraft (e.g. accessories that use high amounts of electrical power).

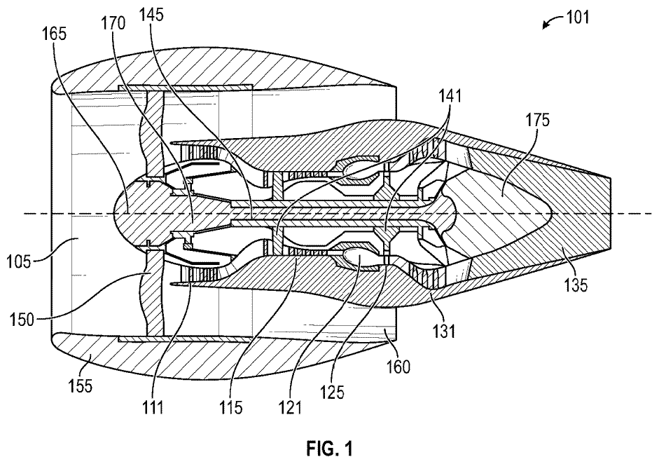

FIG. 1 a side cross-sectional view of an example turbofan 101. In the turbofan 101, air enters a compressor through an inlet 105. That air is first compressed by a low-pressure (LP) compressor 111 and then a high-pressure (HP) compressor 115 before being fed into a combustor 121 where jet fuel is added and combusted. Following combustion, the hot gases created are fed into a high pressure (HP) turbine 125 and then into a low pressure (LP) turbine 131 before being ejected through a tuned passage 135. Other embodiments may have more or less compressor and/or turbine sections, and may have more or less gearing than the turbofan 101 shown in FIG. 1.

The HP turbine 125 is linked via a shaft 141 to the HP compressor 115, and may have gearing as desired. Although not shown in FIG. 1, in various embodiments, the shaft 141 may also be connected to the LP compressor 111, rather than the LP compressor 111 being connected to the shaft 145 as discussed below. The shaft 141 may further have gearing with respect to the LP compressor 111 as desired. The shaft 141, whether connected to one or both of the LP compressor 111 and/or the HP compressor 115 operates to maintain engine function throughout use of the turbofan 101.

Power and heat present in the products of combustion and not extracted by the HP turbine 125 may be extracted by the LP turbine 131. This power is transmitted via the shaft 145 and may be used to drive a bypass fan 150. As discussed above, the shaft 145 may also be connected to the LP compressor 111, or may not be. This bypass fan 150 draws in cool air from outside into the nacelle 155, adds pressure that air, and ejects that air through passage 160 resulting in substantial forward thrust. The design of bypass fan 150, nacelle 155, and air passage 160 enables forward flight at very high speeds, for example up to and including 400 knots indicated airspeed (400 kias) or even higher.

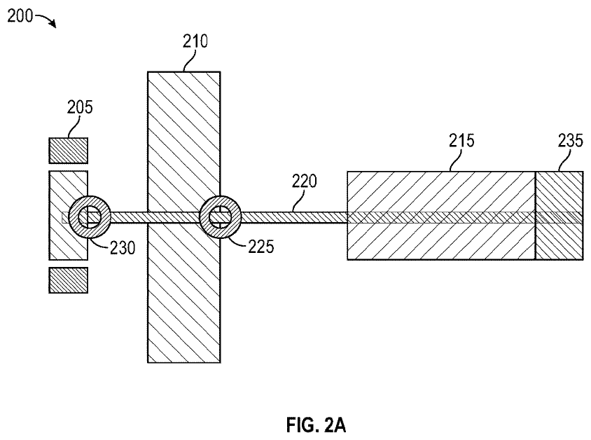

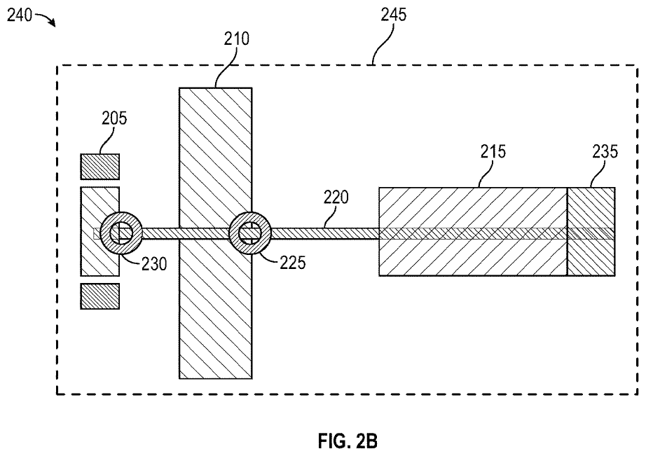

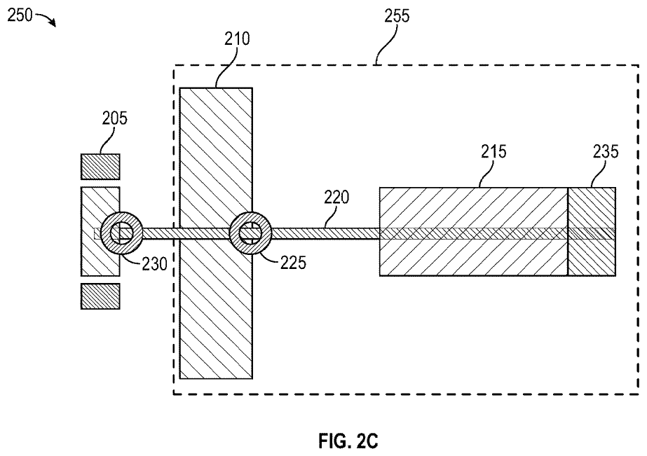

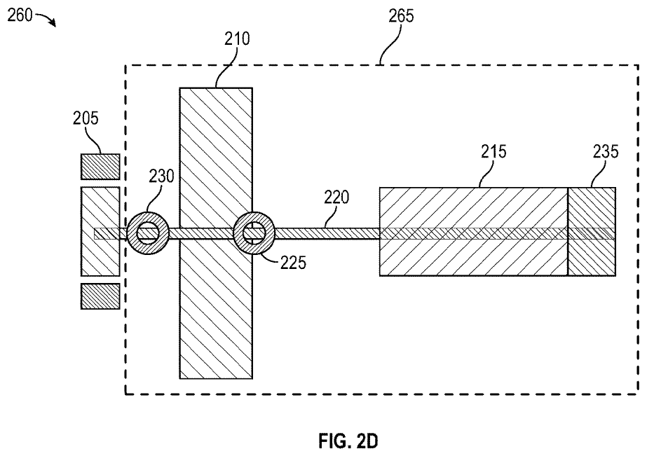

As further described herein, a turbofan such as the turbofan 101 of FIG. 1 may further include an electric machine that is connected in parallel to the turbofan (e.g., to the shaft 145) to generate electric power based on the rotational power output by the shaft 145 of the turbofan. Such an electric machine may be located at different locations of the turbofan, such as at any or all locations 165, 170, and/or 175 of the turbofan 101 of FIG. 1. In another embodiment, an electric machine may be located within the shaft 145 where the shaft 145 is hollow. In other embodiments, an electric machine may be located within or outside the nacelle 155 and/or a housing of the turbine engine of the turbofan 101. For example, an electric machine may be located forward of the nacelle and/or displaced radially from the nacelle. If located forward of the nacelle, the electric machine may be placed far forward of the nacelle such that the electric machine is not in the airstream into the turbofan or otherwise does not significantly affect the airstream into the turbofan, so as not to negatively impact the efficiency of the turbofan. Similarly, the electric machine may be placed at a radial distance from a center axis of the nacelle such that the electric machine is not in the airstream into the turbofan or otherwise does not significantly affect the airstream into the turbofan. In various embodiments, the electric machine may be located both forward and radially displaced from the nacelle. Configurations of an electric machine connected to a turbofan in a parallel configuration with one or more clutches is further discussed below with respect to FIGS. 2A-2D, 3, and 4. In various embodiments, any mechanisms for selectively engaging rotating components other than a clutch may be used. For example, gearing or other transmissions without a clutch may be used as mechanisms for selectively engaging different components described herein instead of a clutch.

By adding such an electric machine (e.g., generator) to a turbofan, the powerplant can operate as a hybrid powerplant, providing both forward thrust and electric power. Such embodiments advantageously enable DEP at very high power levels. Specifically, an electric machine such as an electric motor/generator may be added somewhere along the shaft 145 or driven by the shaft through a bevel or other gearing arrangement, such that the shaft 145 and/or other components carry power from the LP turbine to the bypass fan, and clutches may further be added in specific locations to enable multiple valuable operating modes also described herein.

While the term electric machine (or emachine) is used herein, such a term may refer to a generator, a motor, or a generator/motor combination, as an electric motor may also operate as a generator for example. Similarly, a generator may also be operated as a motor by changing the control and commutation strategy. In various embodiments described herein, the use of such a motor/generator is not to take power from an onboard energy storage system and add shaft power to supplement or replace the power of the core thermal engine, but may be to extract power created by an LP turbine and transmitted by a shaft such as shaft 145 and operate as a generator to create very high electrical power for other use on the aircraft (though in some modes of operation, as described herein, power may be applied to the shaft of a turbofan by an electric machine operating as a motor). This power may be, for example, at a high voltage at or above approximately 400 volts (V), or anywhere from 400V to 2.4 kilovolts (kV). For example, nominal voltages of such a system may include 800V or 1200V. However, in various embodiments as described herein, the use of the emachine may also include using power from a power source such as battery to output power from the emachine to the shaft 145.

Such a high voltage and/or high current electrical power may be used for propulsion, lift, and/or control in an aircraft featuring one or more electric motors driving fans, propellers, or other devices. Such high voltage and/or high current may also be used for any other functions on a given aircraft requiring high electrical power. The total electrical output of a turbofan with an emachine as described herein may, for example, be used for one or a combination of accessories or other aspects of an aircraft, such as those that may use power of one megawatt (1 MW) or even greater.

In various embodiments, the motor/generator may be located anywhere along the length of the turbofan engine or outside of a turbofan engine housing and/or nacelle housing. In an embodiment, the motor/generator may be a short distance forward of the bypass fan (e.g., housed in the shroud (spinner) of the turbofan, such as at the position 165 of the turbofan 101 in FIG. 1), or may be farther forward and more distant from the bypass fan. As other examples, FIGS. 2A-2D shows a motor/generator that may be located forward of the bypass fan.

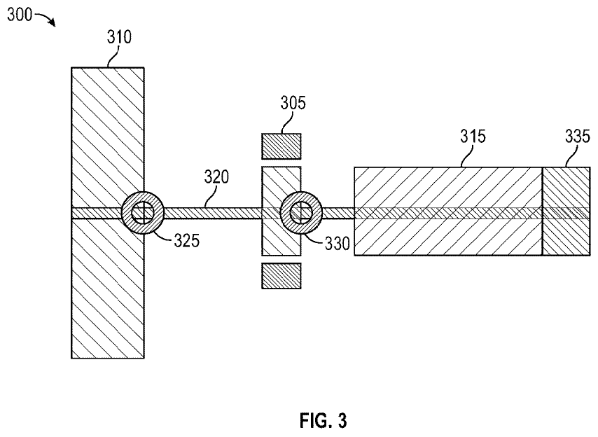

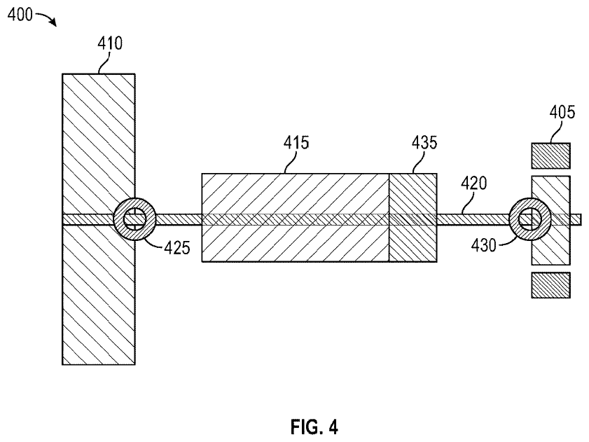

In FIG. 2A, a parallel hybrid powerplant 200 has a turbofan 210, a core thermal engine 215, and a LP turbine 235. These components may be similar to the components of the turbofan 101 shown in FIG. 1. The powerplant 200 further includes a shaft 220 that is configured to power the bypass fan 210 and/or an emachine 205. The emachine 205 may be selectively powered by engaging a mechanism such as clutch 230, and the bypass fan 210 may be selectively powered by engaging a mechanism such as clutch 225. The clutches 230 and 225 may be engaged separately or at the same time. The system may further have one or more gear boxes for converting power that is output from the LP turbine 235 as desired for the bypass fan 210 and/or the emachine 205. For example, one or more gear boxes may be located anywhere along the shaft 220, near one or both of clutches 225 and/or 230, at or near the bypass fan 210, and/or at or near the emachine 205. In various embodiments, components of an electric machine may also be configured to spin without generating (outputting) or using electricity. As such, in various embodiments, a clutch may be omitted or not used between an emachine and a shaft (e.g., there may not be the clutch 230 in FIGS. 2A-2D, the clutch 330 in FIG. 3, and/or the clutch 430 in FIG. 4 in various embodiments), because the emachine may be agnostic to the spinning of a shaft by changing the field current in the emachine to either allow power to pass through unaffected (e.g., the shaft spins without the emachine generating or using electricity) or capture power from the shaft to generate electricity (e.g., the power from the spinning shaft is used to generate electricity). In various embodiments, other clutches (e.g., clutches 225, 325, 425 associated with components of a turbine engine) may also be omitted or not used.

In various embodiments, different configurations of shafts and/or clutches (or other mechanisms than clutches capable of selectively engaging the components of the various components described herein) may also be used. For example, in FIG. 2A it is contemplated that the shaft 220 extends from the LP turbine 235, through the bypass fan 210 and into the emachine 205. In such a configuration, the clutch 225 may, for example, may engage the shaft 220 with an internal shaft of the bypass fan 210 when it is desired that the LP turbine 235 power the bypass fan 210. In this way, when it is not desirable to rotate the bypass fan 210, the shaft 220 may continue to rotate within the bypass fan 210 without rotating the bypass fan 210 because the clutch 225 has disengaged the shaft 220 and a shaft of the bypass fan 210. Then the LP turbine 235 may be used to power the emachine 205 (while the clutch 230 engages the shaft 220 with a shaft of the emachine 205).

In various embodiments, the shaft 220 depicted in FIG. 2A (or any of the other shafts described herein) may be split at different clutch locations. For example, a first shaft may connect the LP turbine 235 and the clutch 225, a second shaft may connect the clutch 225 and the clutch 230, and a third shaft may connect the clutch 230 and the emachine 205. In such an embodiment, both clutches 225 and 230 may be engaged in order to power the emachine 205 with rotational power output by the LP turbine 235. As such, the shaft 220 may actually be three different shafts that may be connected together to operate as one shaft by the clutches 225 and 230. In such an example, the first shaft connecting the LP turbine 235 and the clutch 225 may be permanently connected to the LP turbine 235 and a first side of the clutch 225. The second shaft connecting the clutch 225 and the clutch 230 may be permanently connected to a second side of the clutch 225, a first side of the clutch 230, and the bypass fan 210. The third shaft connecting the clutch 230 and the emachine 205 may be permanently connected to a second side of the clutch 230 and the emachine 205. Even if not described in detail below for every embodiment, it will be understood that in any of the embodiments described herein (e.g., any of FIGS. 2A-2D, 3, 4, etc.) the shafts described herein may be split shafts that are connectable via the various clutches described herein or may represent solid shafts that pass through a clutch that is configured to engage with the single shaft to rotate a component (e.g., a bypass fan, an emachine, an LP turbine) as described herein. In various embodiments, different types of clutches and split or non-split shaft configurations may be used in the same embodiment.

In FIG. 2B, a housing 245 of a powerplant 240 is shown. The powerplant 240 may have similar components to the powerplant 200, but the housing 245 may encompass all of the components including the emachine 205 and its associated clutch 230. The housing 245 may be, for example, a nacelle of the hybrid turbofan or a shroud of just an engine/turbine of the hybrid turbofan.

In FIG. 2C, a housing 255 of a powerplant 250 is shown. The powerplant 250 may have similar components to the powerplants 200 and 240, but the housing 255 may encompass all of the components except the emachine 205, the clutch 230, and a portion of the shaft 220. As such, the emachine 205, the clutch 230, and a portion of the shaft 220 may be located outside of a housing in which the rest of the hybrid powerplant 250 is located. The housing 255 may be, for example, a nacelle of the hybrid turbofan or a shroud of just an engine/turbine of the hybrid turbofan.

In FIG. 2D, a housing 265 of a powerplant 260 is shown. The powerplant 260 may have similar components to the powerplants 200, 240, and 250, but the housing 265 may encompass all of the components except the emachine 205 and a portion of the shaft 220. As such, the emachine 205 and a portion of the shaft 220 may be located outside of a housing in which the rest of the hybrid powerplant 260 is located. The housing 265 may be, for example, a nacelle of the hybrid turbofan or a shroud of just an engine/turbine of the hybrid turbofan.

FIG. 3 shows an example of a hybrid powerplant 300 where an emachine 305 is located between a bypass fan 310 and the turbine engine (e.g., the core thermal engine 315 and LP turbine 335). The emachine 305 may therefore be at the location 170 and may be within a housing, shaft, and/or other portion of the turbofan. Although a housing of the hybrid powerplant 300 is not shown in FIG. 3, the emachine 305 may be within a housing (e.g., nacelle or shroud) of the powerplant 300. The clutch 330 may be used to selectively connect the emachine 305 to a shaft 320 to power the emachine 305, and the clutch 325 may be used to selectively connect the shaft 320 to the bypass fan 310 to power the bypass fan 310.

FIG. 4 further shows an example of a hybrid powerplant 400 where an emachine 405 is physically located near the aft section of the turbofan, behind an LP turbine section 435 where power output via the shaft 420 is created. For example, the emachine 405 may be located inside or outside a housing or nacelle of a turbofan. The clutch 430 may be used to selectively connect the emachine 405 to a shaft 420 to power the emachine 405, and the clutch 425 may be used to selectively connect the shaft 420 to the bypass fan 410 to power the bypass fan 410. Although a housing of the hybrid powerplant 400 is not shown in FIG. 4, the clutch 430 and/or the emachine 405 may be located within a housing (e.g., nacelle or engine shroud) or outside of such a housing.

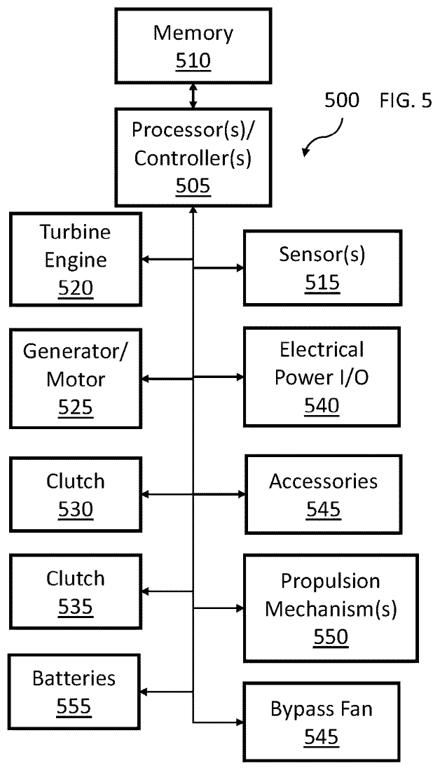

FIG. 5 illustrates a block diagram representative of a control system 500 for use with a hybrid powerplant system in accordance with an illustrative embodiment. The aircraft control system 500 may be used, for example, to implement one or more of the various modes of operation of a hybrid powerplant discussed below. Engine 520 of the system 500 may be the same as or similar to the combustion engine portion of any of the turbofans described herein. The bypass fan 545 may be the same as or similar to any of the bypass fans described herein. The generator/motor 525 may be the same as or similar to any of the emachines described herein. The clutches 530 and 535 may be the same as or similar to any of the clutches described herein.

The aircraft control system 500 may further include one or more processors or controllers 505 (hereinafter referred to as the controller 505), memory 510, an electrical power I/O 540, accessories 545, one or more sensor(s) 515, one or more propulsion mechanism(s) 550, and an electric power source such as batteries 555. The connections in FIG. 5 indicate control signal related connections between components of the aircraft control system 500. Other connections not shown in FIG. 5 may exist between different aspects of the aircraft and/or aircraft control system 500 for providing electrical power, such as a high voltage (HV) or low voltage (LV) power for an aircraft. The electrical power I/O 540 may be the physical connections of the generator/motor 525 to one or more busses or wiring of an aircraft, so that power may be distributed throughout the aircraft. The electrical power I/O 540 may also be or may include sensors such as voltage or current sensors configured to measure aspects of the power flowing into or out of the generator/motor 525. Thus, the controller 505 may be configured to monitor and/or control the power going into or out of the generator/motor 525.

The memory 510 may be a computer readable media configured for instructions to be stored thereon. Such instructions may be computer executable code that is executed by the controller 505 to implement the various methods and systems described herein, including the various modes of using the hybrid powerplants described herein, as well as combinations or particular sequences of those modes. The computer code may be written such that the various methods of implementing different modes of the hybrid powerplants herein are automatically implemented based on various inputs that indicate, for example, a particular flight phase (e.g., landing, takeoff, cruising, etc.). In various embodiments the computer code may be written to implement the various modes herein based on input from a user or pilot of the aircraft or aerospace vehicle, or may be implemented based on a combination of user input and automatic implementation based on non-human inputs (e.g., from sensors on or off the aircraft, based on planned flight plans, etc.). The controller 505 may be powered by a power source on the aircraft or aerospace vehicle, such as the generator/motor 525, one or more batteries 555, the electrical power I/O 540, a power bus of the aircraft powered by any power source, and/or any other power source available.

The controller 505 may also be in communication with each of components in FIG. 5. In this way, the components of hybrid powerplants as described herein may be controlled, including to implement various modes as described herein.

The sensor(s) 525 may include various sensors for monitoring the different components of a hybrid powerplant. Such sensors may include temperature sensors, tachometers, fluid pressure sensors, voltage sensors, current sensors, state sensors to determine, for example, a current state of the clutches 530 and/or 535, a current state of any gear boxes, or any other type of sensor. For example, voltage and/or current sensors may be used to inform function and settings of a motor/generator, a state chosen for the clutch, or for adjusting any other component of a system. A state sensor could also indicate a specific mode the hybrid powerplant is being used in, and the system may receive inputs (e.g., from a pilot, from an automated flight controller), to change the system to a different state or mode for a certain phase of flight that may be upcoming. Other sensors may include a pitot tube for measuring aircraft airspeed, an altimeter for measuring aircraft altitude, and/or a global positioning system (GPS) or similar geographic location sensor for determining a location relative to the ground and/or known/mapped structures.

In various embodiments, the controller 505 may also be in communication with one or more batteries or battery management systems to monitor their charge levels, control when the batteries are charged or discharged, control when the batteries are used to power the generator/motor 525, control when the batteries are used to directly power another aspect of the aircraft, etc.

In some embodiments, the controller 505 may be in communication with devices hardwired to the controller 505 on-board an aircraft, and/or may be in communication with a wireless transceiver that may be on-board an aircraft or aerospace vehicle, so that the controller 505 may communicate with other computing devices not hard-wire connected to the system 500. In this way, instructions or inputs for implementing the various modes for the flexible architectures described herein may also be received from a remote device computing device wirelessly. In other embodiments, the system 500 may only communicate with components on-board the aircraft.

Described further below are different specific modes that may be implemented using various embodiments of the hybrid powerplants described herein.

In a first mode, maximum or near maximum power output from a turbine engine may be directed to an emachine to generate electrical power output. Thus, such a mode may produce little or zero forward thrust as desired. Such a mode may be valuable, for example, during a vertical takeoff and/or landing operation of a VTOL aircraft.

In a second mode, the power generated by a LP turbine and output by an output shaft of a hybrid powerplant may be transmitted wholly or primarily to the bypass fan to create only or primarily forward thrust. Maximum thrust may be desired, for example, during cruising of an aircraft (e.g., between takeoff and landing). As such, in this mode, the aircraft may minimize other power draw from the shaft (e.g., by the emachine) so that an aircraft may achieve its maximum or near-maximum speed.

In a third mode some combination of forward thrust and electrical power generation may be desired. For example, such a mode may be used during transition from forward flight to a vertical takeoff and/or landing operation (which may be powered by electric power), for example. This mode may also be employed when the pilot (e.g., human or autonomous) desires to sacrifice maximum speed capability (and therefore lower forward thrust) to generate high electrical power for other uses on the airplane, such as high-power accessories. This mode of operation may also be used/desirable where it is desirable to maintain a minimum airflow through a core thermal engine of a turbofan even if no forward thrust is desired. In other words, through rotation of the bypass fan, air may still be passed through a turbine engine as desired without drawing an excessive amount of power to do so, allowing significant power to still be generated by an emachine.

A fourth mode may be used where some forward thrust may be desired from the bypass fan of the turbofan without starting or operating its core thermal engine. This may be accomplished by driving the motor/generator as an electric motor using onboard energy storage (e.g., such as from a battery). Such operation may be for short bursts of power to the bypass fan, or for an added dimension of safety and survivability should the core thermal engine fail. In order to implement such an operation, an output shaft of the emachine should be coupled to, directly or indirectly, the shaft of the bypass fan so that the bypass fan can actually be driven by the output of the emachine. This may be accomplished by use of one or more clutches as described herein or any other method. In an example, an additional clutch may also be used that is configured to disengage the core thermal engine from the emachine and/or the bypass fan during such a mode of operation, such that a shaft of the core thermal engine does not rotate while the emachine drives the bypass fan. In other words, in various embodiments, an LP turbine shaft may be disengaged from the shaft of a bypass fan using an additional clutch than those shown in any of FIGS. 2A-2D, 3, and/or 4. In an example embodiment where a split shaft is used, such as FIG. 2A for example, an emachine may power a bypass fan without rotating the LP turbine without the addition of another clutch. In the example of FIG. 2A where the shaft is split at each clutch, the clutch 225 may be disengaged while the clutch 230 is engaged, such that the emachine 205 may output power to rotate the bypass fan 210, but the portion of the shaft between clutch 225 and the LP turbine 235 does not rotate due to the clutch 225 being disengaged. In this way, either through an additional clutch at the LP turbine or through use of a shaft that is split at a clutch, the bypass fan may be rotated without rotation of the LP turbine section. In various embodiments, it may be acceptable for the LP turbine section to rotate even while the core thermal engine is not being used, such that the emachine can power the bypass fan while rotating the LP turbine section.

In order to facilitate these modes of the parallel hybrid powerplant operation, the system may include at least one clutch as described herein. For example, a clutch for functionally connecting/disconnecting the LP turbine shaft to a motor/generator may be used. This clutch may be referred to herein as the emachine clutch. The emachine clutch may be attached to a rotor or stator of the emachine depending on whether the emachine is an in-runner or out-runner style. A second clutch for functionally connecting/disconnecting the LP turbine shaft to a bypass fan may also be used. This clutch may be referred to herein as the bypass fan clutch.

The first mode above may be implemented by closing the emachine clutch and opening the bypass fan clutch, such that all power from the LP turbine shaft is driven to the emachine. The second mode described above may be implemented by opening the emachine clutch and closing the bypass fan clutch, such that all LP turbine shaft power is transmitted to the bypass fan.

The third mode described above may be implemented by fully or partially closing both of the emachine and the bypass fan clutches. If both clutches are fully closed, the motor/generator and the bypass fan may spin at the same rotations per minute (RPM) and the division of power may be controlled by an inverter of the motor/generator and control of the field current, for example. If one or the other clutch is partially closed, control of the clutch pressure may serve to divide power with a suitable controller and clutch pressure actuator. Accordingly, one or both of the clutches may be controlled to control how much power is transmitted from the shaft to either of the emachine or the bypass fan. If the clutches are used in this way, the clutches may generate heat, and the system therefore may be configured to provide cooling to one or both of the clutches as desired to keep one or both of the clutches at a desired temperature. An additional implementation for the third mode of operation may include where thrust from the bypass fan is vectored downward and coupled with lift created by electric fans to create a stable VTOL platform. This vectoring may be via a reconfigurable nozzle or other deflectors at an aft end of a turbofan, and/or by rotating the turbofan.

In the fourth mode of operation described above, the relative locations of the emachine and the clutches may influence what operational state they are in to implement the fourth mode. As long as there is a connection between the emachine and the bypass fan via the shaft, the emachine may power the bypass fan. In addition, a hybrid powerplant may further be configured such that the LP turbine shaft is configured to be disconnected from the core thermal engine (e.g., through a clutch), such that components of the engine do not rotate while the emachine powers the bypass fan. In a similar mode, the emachine may be used to power the bypass fan, but the engine may be further used to power the bypass fan such that a maximum power even higher that what the engine may be able to output is applied to the bypass fan. In any case, the presence of an energy storage system (such as a battery) may be used to provide electrical power to the emachine and therefore the bypass fan of a hybrid powerplant.

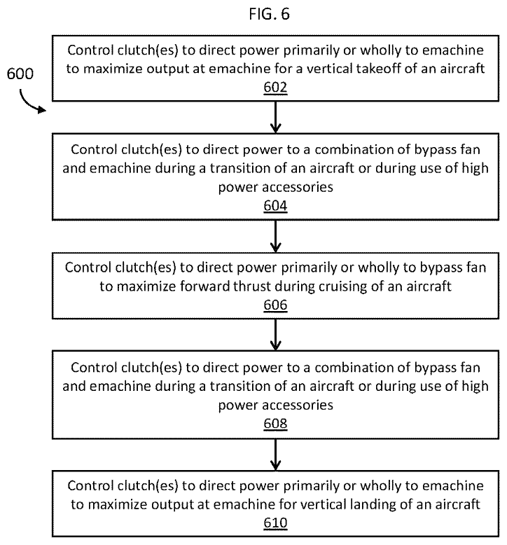

FIG. 6 is a flow chart illustrating a method 600 of using a hybrid powerplant having a turbofan engine core as described herein. For example, at 602, one or more clutches of a hybrid powerplant may be controlled such that power is directed primarily or wholly to an emachine to maximize output of electrical power from the emachine. This may be useful for providing high power to electric motors that facilitate a vertical takeoff of a VTOL aircraft, for example. This may be implemented using the first mode described above.

At 604, the clutches may be controlled to direct power to a combination of the bypass fan and emachine. This may be useful, for example, during a transition from vertical flight to cruising/horizontal flight for taking off of an aircraft and/or while an aircraft is cruising but it is desirable to direct significant electrical power to an accessory or other component of an aircraft. This may be implemented using the third mode described above.

At 606, the clutches may be controlled to direct power primarily or wholly to the bypass fan to maximize forward thrust, for example during cruising or horizontal flight of an aircraft. This may be implemented using the second mode of operation described above.

At 608, similar to 604, the clutches may be controlled to direct power to a combination of the bypass fan and emachine. This may be useful, for example, during a transition from cruising/horizontal flight to vertical flight for landing of an aircraft and/or while an aircraft is cruising but it is desirable to direct significant electrical power to an accessory or other component of an aircraft. This may be implemented using the third mode described above.

At 610, similar to 602, the clutches of a hybrid powerplant may be controlled such that power is directed primarily or wholly to an emachine to maximize output of electrical power from the emachine. This may be useful for providing high power to electric motors that facilitate a vertical landing of a VTOL aircraft, for example. This may be implemented using the first mode described above.

As such, using the method 600, a VTOL aircraft may implement all stages of a desired flight, including vertical takeoff (602), transition from vertical to horizontal flight (604), horizontal/cruising flight (606), transition from horizontal to vertical flight (608), and vertical landing (610).

Other advantages of the systems and methods described herein may also be taken advantage of in an aircraft that uses the hybrid powerplants. For example, the available electrical power being generated by a single emachine in the embodiments described herein may be anywhere from 4 MW to 10 MW per hybrid powerplant.

In some embodiments where a high system voltage is desired for an aircraft (e.g., 800 Volts DC (VDC), 1000 VDC, 1200 VDC), there may be an available current from an emachine in a range of about 3200 amps (A), 4000 A, or 4800 A. Conventional copper wires, like any conductor, are limited in their ability to carry current based on their inherent internal heat generation and dissipation, strength, weight (density), and other practical limits/constraints such as manufacturing tolerances and transportation limits. Considering the limitations inherent to copper wire, the emachine for this high-power application may be designed in multiple sectors where each sector generates only a portion of the total power and wires carrying current from the sector carry only a fraction of the total current. Emachines designed in this manner may have multiple sectors, such as anywhere from 2-24 sectors, such as 2 sectors, 4 sectors, 6 sectors, 8 sectors, 12 sectors, 16 sectors, 20 sectors, or 24 sectors. An emachine designed in such a way may also be connected directly to multiple inverters, each controlling one or more sectors but less than all the sectors of the emachine.

A high-voltage DC bus layout for use with distributed electric propulsion (DEP) may be singular, meaning that all power generated or stored in an aircraft is fed onto a single DC bus (e.g., a bus having 2 wires-positive and negative (or positive and ground)) and all motors or consumers of electrical power are electrically connected to the same singular bus. With the high power that may be generated by the turbofan hybrid powerplants described herein, the electrical power may be carried on multiple parallel DC busses. These multiple DC busses may be at the same system voltage, such as 1000 VDC for example. They may connect to multiple inverters controlling sectors (but not all sectors) of the main emachine and they may feed in different directions to consumers of power such as electric motors for lift or control. One example may be a single hybrid generator with 12 sectors feeding 12 inverters. Those 12 inverters may output to 12 high-voltage DC busses, and 4 busses may be fed to a lift motor at a tip of a left wing, 4 more busses may be fed to a lift motor at a tip of a right wing, and 4 more busses may be fed to a lift motor in a tail of the aircraft, for example. In other words, different busses may be used and configured to move power to different portions of an aircraft. Other connections between busses may be selectively controlled to allow power to flow from one bus to another, or from one group of busses to another as desired.

The high levels of electrical power that may be generated using the hybrid powerplants described herein may also be more efficiently used with wires that have more desirable conductivity properties than copper wires. For example, aluminum wires may be used rather than copper. Considering their conduction and density, aluminum wires may reduce wire weight for a given conductor at high power levels by roughly 50%. In another example, wires made wholly or partially from specific superconducting materials may be used. In various embodiments, cooling equipment may also be used to keep superconducting or other materials at a desired temperature to reduce power loss. In various configurations, such aluminum or superconducting wiring (including possible associated cooling systems) may reduce overall system weight as compared to a copper wire system designed for a same or similar power output. The superconducting wiring may be, for example, bismuth strontium calcium copper oxide (BSCCO) or any other type of suitable superconducting material.

As described herein, the emachines may generate or use alternating current (AC), and the emachine may be connected to an inverter, so that AC power output by the emachine may be converted to DC power for a bus of an aircraft. (The inverter may also convert DC from a bus to AC power for input into the emachine to power a LP turbine shaft as described with respect to the fourth mode above.) At an other end of a DC bus opposite the emachine, DC power may be fed into another inverter which converts the DC power back to AC power in order to drive an electric motor (e.g., to produce lift or control for an aircraft). In order to reduce weight on an aircraft, AC power may be fed directly from an emachine to an electric motor. In various embodiments where the emachine is in multiple sectors, each having an associated bus or busses (e.g., wiring), such a feature may be further enhanced by feeding the AC power generated only by certain sectors of the emachine directly to an electric motor without the use of inverters and/or a DC bus. In such an embodiment, some sectors of the emachine may still have inverters for converting AC power to DC power for a DC bus, while other sectors may be configured to feed power directly to an electric motor or other equipment that requires AC electric power.

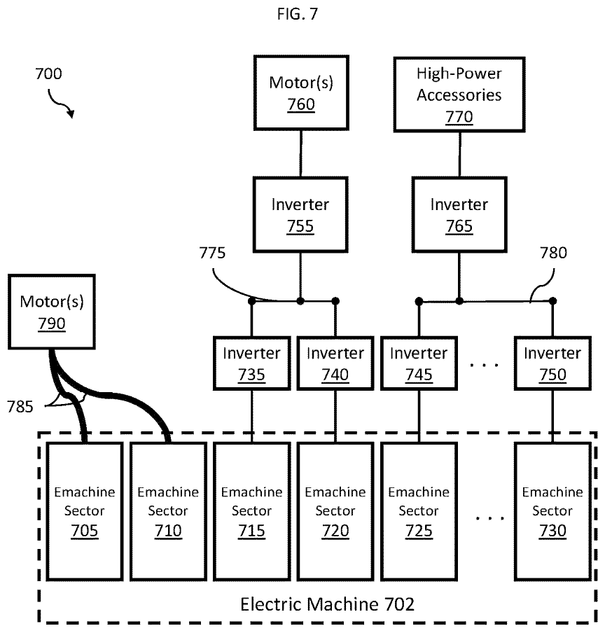

FIG. 7 illustrates a block diagram 700 representative of such an electric machine having a plurality of segments used as a system for powering aircraft components with the segmented electric machine. In particular, FIG. 7 shows how a segmented emachine may generate electric power that is output directly to devices such as motors, to one or more DC busses, etc.

Shown in FIG. 7 is an electric machine 702 with at least 6 sectors 705, 710, 715, 720, 725, 730. As described herein an electric machine may have any number of sectors as desired. FIG. 7 shows just one possible configuration of a number of sectors and how they are connected to other devices and/or busses in system. In various other embodiments, different numbers of electric machines, sectors busses, other devices, etc. may be used.

In the example of FIG. 7, sectors 705 and 710 are connected to motor(s) 790 directly via wiring 785. The wiring 785 shown in FIG. 7 may represent one or more pairs of wires running from each sector 705 and 710 to the motor(s) 790. The wiring 785 may also be or include an AC bus. In addition, the motor(s) 790 may be one or more motors or other devices/accessories that use alternating current (AC) power output by the sectors 705 and 710. In this way, some AC power from the electric machine 702 may be output directly to certain devices.

Sectors 715 and 720 are connected to inverters 735 and 740, respectively, so that AC power output by the sectors 715 and 720 may be converted to DC power by the inverters 735 and 740 and output to a DC bus 775. The DC bus 775 may be used to power various components of an aircraft, such as motor(s) 760. The motor(s) 760 is connected to the DC bus 775 via an inverter 755, so that the inverter 755 can convert DC power from the DC bus 775 to AC power for the motor(s) 760.

The sectors 725 and 730 are connected to inverters 745 and 750, respectively, so that AC power output by the sectors 725 and 730 may be converted to DC power by the inverters 745 and 750 and output to a DC bus 780. The DC bus 780 may be used to power various components of an aircraft, such as high-power accessories 770. The high-power accessories 770 are connected to the DC bus 780 via an inverter 765, so that the inverter 765 can convert DC power from the DC bus 780 to AC power for the high-power accessories 770. In various embodiments, if one or more of the high power accessories 770 uses DC power, such an accessory may be connected to the DC bus without use of an inverter.

In various embodiments, an aircraft may also have a power source such as one or more batteries. Those batteries may be connected to one or more of the DC busses 775 and 780, and thereby supply DC power to and/or receive DC power from the busses 775 and 780. In this way, the batteries may be either charged by or be able to send power to devices on an aircraft. For example, such batteries may be charged ultimately using electric energy generated by sectors of the electric machine 702. Such batteries may also be used as described herein to power the electric machine 702, for example to drive an LP turbine shaft via the electric machine 702 as described herein.

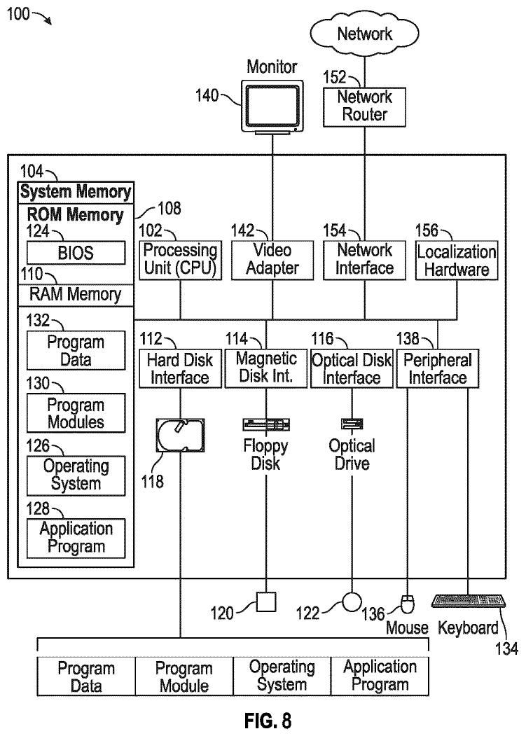

FIG. 8 is a diagrammatic view of an example of a computing environment that includes a general-purpose computing system environment 100, such as a desktop computer, laptop, smartphone, tablet, or any other such device having the ability to execute instructions, such as those stored within a non-transient, computer-readable medium. Various computing devices as disclosed herein (e.g., the processor(s)/controller(s) 505, the memory 510, a combination of the two, or any other computing device in communication with such that may be part of other components of an aircraft or a controller off the aircraft) may be similar to the computing system 100 or may include some components of the computing system 100. Furthermore, while described and illustrated in the context of a single computing system 100, those skilled in the art will also appreciate that the various tasks described hereinafter may be practiced in a distributed environment having multiple computing systems 100 linked via a local or wide-area network in which the executable instructions may be associated with and/or executed by one or more of multiple computing systems 100.

In its most basic configuration, computing system environment 100 typically includes at least one processing unit 102 and at least one memory 104, which may be linked via a bus 106. Depending on the exact configuration and type of computing system environment, memory 104 may be volatile (such as RAM 110), non-volatile (such as ROM 108, flash memory, etc.) or some combination of the two. Computing system environment 100 may have additional features and/or functionality. For example, computing system environment 100 may also include additional storage (removable and/or non-removable) including, but not limited to, magnetic or optical disks, tape drives and/or flash drives. Such additional memory devices may be made accessible to the computing system environment 100 by means of, for example, a hard disk drive interface 112, a magnetic disk drive interface 114, and/or an optical disk drive interface 116. As will be understood, these devices, which would be linked to the system bus 306, respectively, allow for reading from and writing to a hard disk 118, reading from or writing to a removable magnetic disk 120, and/or for reading from or writing to a removable optical disk 122, such as a CD/DVD ROM or other optical media. The drive interfaces and their associated computer-readable media allow for the nonvolatile storage of computer readable instructions, data structures, program modules and other data for the computing system environment 100. Those skilled in the art will further appreciate that other types of computer readable media that can store data may be used for this same purpose. Examples of such media devices include, but are not limited to, magnetic cassettes, flash memory cards, digital videodisks, Bernoulli cartridges, random access memories, nano-drives, memory sticks, other read/write and/or read-only memories and/or any other method or technology for storage of information such as computer readable instructions, data structures, program modules or other data. Any such computer storage media may be part of computing system environment 100.

A number of program modules may be stored in one or more of the memory/media devices. For example, a basic input/output system (BIOS) 124, containing the basic routines that help to transfer information between elements within the computing system environment 100, such as during start-up, may be stored in ROM 108. Similarly, RAM 110, hard drive 118, and/or peripheral memory devices may be used to store computer executable instructions comprising an operating system 126, one or more applications programs 128 (which may include the functionality disclosed herein, for example), other program modules 130, and/or program data 122. Still further, computer-executable instructions may be downloaded to the computing environment 100 as needed, for example, via a network connection.

An end-user may enter commands and information into the computing system environment 100 through input devices such as a keyboard 134 and/or a pointing device 136. While not illustrated, other input devices may include a microphone, a joystick, a game pad, a scanner, etc. These and other input devices would typically be connected to the processing unit 102 by means of a peripheral interface 138 which, in turn, would be coupled to bus 106. Input devices may be directly or indirectly connected to processor 102 via interfaces such as, for example, a parallel port, game port, firewire, or a universal serial bus (USB). To view information from the computing system environment 100, a monitor 140 or other type of display device may also be connected to bus 106 via an interface, such as via video adapter 132. In addition to the monitor 140, the computing system environment 100 may also include other peripheral output devices, not shown, such as speakers and printers.

The computing system environment 100 may also utilize logical connections to one or more computing system environments. Communications between the computing system environment 100 and the remote computing system environment may be exchanged via a further processing device, such a network router 152, that is responsible for network routing. Communications with the network router 152 may be performed via a network interface component 154. Thus, within such a networked environment, e.g., the Internet, World Wide Web, LAN, or other like type of wired or wireless network, it will be appreciated that program modules depicted relative to the computing system environment 100, or portions thereof, may be stored in the memory storage device(s) of the computing system environment 100.

The computing system environment 100 may also include localization hardware 186 for determining a location of the computing system environment 100. In some instances, the localization hardware 156 may include, for example only, a GPS antenna, an RFID chip or reader, a WiFi antenna, or other computing hardware that may be used to capture or transmit signals that may be used to determine the location of the computing system environment 100.

While this disclosure has described certain embodiments, it will be understood that the claims are not intended to be limited to these embodiments except as explicitly recited in the claims. On the contrary, the instant disclosure is intended to cover alternatives, modifications and equivalents, which may be included within the spirit and scope of the disclosure. Furthermore, in the detailed description of the present disclosure, numerous specific details are set forth in order to provide a thorough understanding of the disclosed embodiments. However, it will be obvious to one of ordinary skill in the art that systems and methods consistent with this disclosure may be practiced without these specific details. In other instances, well known methods, procedures, components, and circuits have not been described in detail as not to unnecessarily obscure various aspects of the present disclosure.

Some portions of the detailed descriptions of this disclosure have been presented in terms of procedures, logic blocks, processing, and other symbolic representations of operations on data bits within a computer or digital system memory. These descriptions and representations are the means used by those skilled in the data processing arts to most effectively convey the substance of their work to others skilled in the art. A procedure, logic block, process, etc., is herein, and generally, conceived to be a self-consistent sequence of steps or instructions leading to a desired result. The steps are those requiring physical manipulations of physical quantities. Usually, though not necessarily, these physical manipulations take the form of electrical or magnetic data capable of being stored, transferred, combined, compared, and otherwise manipulated in a computer system or similar electronic computing device. For reasons of convenience, and with reference to common usage, such data is referred to as bits, values, elements, symbols, characters, terms, numbers, or the like, with reference to various presently disclosed embodiments.

It should be borne in mind, however, that these terms are to be interpreted as referencing physical manipulations and quantities and are merely convenient labels that should be interpreted further in view of terms commonly used in the art. Unless specifically stated otherwise, as apparent from the discussion herein, it is understood that throughout discussions of the present embodiment, discussions utilizing terms such as “determining” or “outputting” or “transmitting” or “recording” or “locating” or “storing” or “displaying” or “receiving” or “recognizing” or “utilizing” or “generating” or “providing” or “accessing” or “checking” or “notifying” or “delivering” or the like, refer to the action and processes of a computer system, or similar electronic computing device, that manipulates and transforms data. The data is represented as physical (electronic) quantities within the computer system's registers and memories and is transformed into other data similarly represented as physical quantities within the computer system memories or registers, or other such information storage, transmission, or display devices as described herein or otherwise understood to one of ordinary skill in the art.

In an illustrative embodiment, any of the operations described herein may be implemented at least in part as computer-readable instructions stored on a computer-readable medium or memory. Upon execution of the computer-readable instructions by a processor, the computer-readable instructions may cause a computing device to perform the operations.

The foregoing description of illustrative embodiments has been presented for purposes of illustration and of description. It is not intended to be exhaustive or limiting with respect to the precise form disclosed, and modifications and variations are possible in light of the above teachings or from practice of the disclosed embodiments. It is intended that the scope of the invention be defined by the claims appended hereto and their equivalents.

What is claimed is:

1. A hybrid aircraft powerplant comprising:
a turbine engine comprising a first shaft configured to output power from the turbine engine;
a bypass fan;
an electric machine; and
a mechanism configured to selectively engage the first shaft with a second shaft connected to the electric machine such that the power is output from the turbine engine to the electric machine.

2. The hybrid aircraft powerplant of claim 1, wherein the mechanism is a clutch, and while the clutch is disengaged, the power from the turbine engine is not output to the electric machine.

3. The hybrid aircraft powerplant of claim 1, wherein the mechanism is a clutch, and while the clutch is engaged, the power from the turbine engine is output to the electric machine.

4. The hybrid aircraft powerplant of claim 1, wherein the mechanism is a first clutch, and wherein the hybrid aircraft powerplant further comprises a second clutch configured to selectively engage the first shaft with a third shaft connected to the bypass fan to output the power from the turbine engine to the bypass fan.

5. The hybrid aircraft powerplant of claim 4, wherein the first clutch and the second clutch are controllable such that the first clutch is engaged to drive the power from the turbine engine to the electric machine while the second clutch is disengaged so as to not drive the power from the turbine engine to the bypass fan machine.

6. The hybrid aircraft powerplant of claim 4, wherein the first clutch and the second clutch are controllable such that the second clutch is engaged to drive the power from the turbine engine to the bypass fan while the first clutch is disengaged so as to not drive the power from the turbine engine to the electric machine.

7. The hybrid aircraft powerplant of claim 4, wherein the first clutch and the second clutch are controllable such that both the first clutch and the second clutch are simultaneously engaged to drive the power from the turbine engine to both the electric machine and the bypass fan simultaneously.

8. The hybrid aircraft powerplant of claim 1, further comprising a gear box attached to the first shaft or the second shaft, wherein the gear box is configured to convert the power that is output from the turbine engine.

9. The hybrid aircraft powerplant of claim 1, wherein the electric machine is an electric generator.

10. The hybrid aircraft powerplant of claim 1, wherein the electric machine is an electric generator/motor combination.

11. A hybrid aircraft powerplant comprising:
a turbine engine comprising a first shaft configured to output power from the turbine engine;
a bypass fan;
an electric machine; and
a mechanism configured to selectively engage the first shaft portion with a second shaft connected to the bypass fan to output the power from the turbine engine to the bypass fan.

12. The hybrid aircraft powerplant of claim 11, wherein the mechanism is a clutch, and while the clutch is disengaged, the power from the turbine engine is not output to the bypass fan.

13. The hybrid aircraft powerplant of claim 11, wherein the mechanism is a clutch, and while the clutch is engaged, the power from the turbine engine is output to the bypass fan.

14. The hybrid aircraft powerplant of claim 11, wherein the mechanism is a first clutch, and wherein the hybrid aircraft powerplant further comprises a second clutch configured to selectively engage the first shaft with a third shaft connected to the electric machine to output the power from the turbine engine to the electric machine.

15. The hybrid aircraft powerplant of claim 11, further comprising a gear box attached to the first shaft or the second shaft, wherein the gear box is configured to convert the power that is output from the turbine engine.

16. A method comprising:
controlling a turbine engine comprising a first shaft to output power via the first shaft;
controlling, in a first mode of operation, a first mechanism to engage the first shaft with a second shaft, wherein the second shaft is connected to an electric generator, such that the power is output from the turbine engine to the electric generator via the first shaft and the second shaft; and
controlling, in a second mode of operation, the first mechanism to engage the first shaft with the second shaft while also controlling a second mechanism to engage the first shaft to a third shaft, wherein the third shaft is connected to a bypass fan, such that the power is output from the turbine engine to each of the electric generator and the bypass fan.

17. The method of claim 16, wherein the first mode of operation is used during a vertical takeoff or landing operation of an aircraft.

18. The method of claim 16, wherein during the first mode of operation, the second mechanism is not engaged to connect the first shaft to the third shaft.

19. The method of claim 16, wherein during the second mode of operation, the bypass fan is configured to produce forward thrust for an aircraft while electric power generated by the electric generator is configured to power electric components of the aircraft.

20. The method of claim 16, further comprising controlling, in a third mode of operation, the second mechanism to engage the first shaft with the third shaft without engaging the first mechanism to engage the first shaft with the second shaft, such that the power is output from the turbine engine to the bypass fan but not the electric generator.

21. A hybrid aircraft powerplant comprising:
a turbine engine comprising a shaft configured to output power from the turbine engine;
a bypass fan; and
an electric machine,
wherein:
the shaft is configured to deliver the output power to the bypass fan and the electric machine;
the electric machine is segmented into a plurality of sectors, such that the electric machine is configured to generate electric power in response to receiving the output power from the turbine engine;
the electric power is output from the electric machine via a plurality of outputs, each one of the plurality of outputs being associated with one of the plurality of sectors of the electric machine.

22. The hybrid aircraft powerplant of claim 21, further comprising a plurality of inverters, wherein each of the plurality of outputs is configured to output alternating current (AC) power to one of the plurality of inverters, and further wherein each of the plurality of inverters is configured to convert the AC power to direct current (DC) power.

23. The hybrid aircraft powerplant of claim 22, wherein the plurality of inverters are configured to output the DC power to one or more DC busses.

24. The hybrid aircraft powerplant of claim 23, wherein the one or more DC busses comprises aluminum wiring.

25. The hybrid aircraft powerplant of claim 23, wherein the one or more DC busses comprises wiring composed of a superconducting material.
